(19) United States
(12) Patent Application Publication
(10) Pub. No.: US 2006/0273891 A1
(43) Pub. Date: Dec. 7, 2006

(54) EMERGENCY STOP SIGNAL DEVICE FOR MOTOR VEHICLE

(76) Inventors: TUAN KIM QUACH, Mira Lorna, CA (US); TONY QUACH, Mira Lorna, CA (US); YANXIA GUO, Phoenix, AZ (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/381,431

(22) Filed: May 3, 2006

Related U.S. Application Data
(60) Provisional application No. 60/677,487, filed on May 3, 2005.

(51) Int. Cl. B60Q 1/50

(52) U.S. Cl. 340/467; 340/479

(57) ABSTRACT

An emergency stop signaling device for vehicles is disclosed, including a deceleration sensor which produces deceleration values, an integrated circuit control circuit which receives the deceleration values and produces LED activation control signals. An LED array lights in response to the LED activation control signals from the Integrated Circuit control circuit to produce a light pattern which is distinguishable from an ordinary braking signal. The deceleration sensor is preferably a digital deceleration sensor. The LED array is a flexible LED array, a portable LED array, a linear LED array or a circular LED or a combination of these. The IC control circuit produces signals which activate the LED array to a plurality modes of activity including a tail light mode, a stop light mode, and a panic stop mode.

The following claims priority from provisional patent application 60/677,487, filed May 3, 2005 to the same inventors.

### TECHNICAL FIELD

The present invention relates generally to the field of signaling devices for motor vehicles, and more particularly to an emergency stop signal for motor vehicles.

### BACKGROUND OF THE INVENTION

In the prior stop signaling technology, no matter with how much pressure the driver steps on the break pedal and no matter how urgent is the stop, the brightness and color of stoplight is same. There is no specific signal to tell whether the stop is a normal stop or a panic stop. If the drivers of rear vehicles can't make a judgment quickly, it may cause a collision accident. Normally, when driving speed is 60 miles per hour, the driver of rear vehicle should take 2-4 second to observe that the front vehicle is reducing speed. Therefore, to provide a specific emergency stop signal can improve drivers' judgment, so that they make take an early action to avoid an accident.

Various signaling systems and apparatus have been disclosed in the following U.S. patents: U.S. Pat. No. 6,225,896 B1, U.S. Pat. No. 5,798,691, and U.S. Pat. No. 5,831,521.

An emergency-stop warning unit and a method for the control thereof, serving to reduce the severity and chance of a rear-end collision, is disclosed in U.S. Pat. No. 6,225,896B1 entitled “PANIC STOP, DECELERATION WARNING SYSTEM”. The unit utilizes a deceleration or collision impact sensor and vehicle electric power-source to turn on the white Reverse-Light upon high deceleration of the vehicle. The deceleration sensor consists of conductive liquid and two conductive contacts. When emergency stops, the liquid level moves, due to inertia and touches the conductive contacts in the sensor to turn on the reverse lights. As a mechanical mechanism, it may not reflect only speed change but also may be triggered by road conditions. Many factors can trigger the sensor, such as vibration, and thus may trigger false alerts.

Another accessory break light system for automobiles is disclosed in U.S. Pat. No. 5,798,691 entitled “ACCESSORY BRAKE LIGHT SYSTEM FOR AUTOMOBILE”. The system includes an elongated housing having a receiving cavity therein and a front transparent shield covering the receiving cavity, and a lighting apparatus having a plurality of brake lighting LEDs mounted within the receiving cavity of the elongated housing. It is mounted at a central position of the front bumper. It provides specific warning signals when a vehicle is braking to slow down or fully stopped. This device uses LEDs as lighting components. The signal is a simple “lights on” mechanism with no variation in intensity corresponding to the intensity of deceleration. Because it is mounted within a front transparent shield, it only warns pedestrians that are positioned in front of the vehicle. Essentially, it is an accessory brake light. There is no component to sense the deceleration. Installation also requires remodeling of the existing vehicle.

Another automatic emergency signal device for vehicles is disclosed in U.S. Pat. No. 5,831,521 entitled “AUTOMATIC EMERGENCY SIGNAL MEANS FOR VEHICLES”. The device includes a casing mounted in a vehicle, a movable weight movable in a groove longitudinally formed in the casing, a sensor actuated by the movable weight due to inertia of the movable weight upon a sudden or emergency braking of the vehicle for sensing a trigger signal. A warning light is mounted at rear portion of a vehicle. When emergency stops, the warning light will be automatically lit. The mechanical sensor senses the deceleration and triggers control circuit to turns on the brake lights automatically. The sensor consists of a movable weight movable in groove. There are preset starting position and target position. When the movable weight reaches the target position, it triggers the device on. The sensor is a mechanical mechanism using inertia when a vehicle sudden stops. Its precision is low. Some road conditions may move movable weight in groove, such as when the vehicle moves downhill or uphill, and thus may provide false alerts. The device apparently provides a single level of activity and only for panic level deceleration.

Thus there is a need for a vehicle emergency stop signal device having a LED array as lighting components instead of lamps, an individual control system which does not impact or alter the existing break and stoplight system, a simple deceleration sensor to trigger the warning signal with fewer false alerts, and which is versatile enough to signal a variety of conditions in addition to only a panic stop.

### DISCLOSURE OF INVENTION

In general, the emergency stop signal device of the present invention uses an LED array to display a series of flashing lights in patterns and colors when a vehicle makes a quick and sudden stop. It is independent from the vehicle's current electrical signal system and will not interfere with the vehicle's current signal system. It can be also integrated with the vehicle's signal system to flash normal braking signals and tail lights. It uses a digital control circuit, with a programmed IC, to control the device to produce various modes of LED activity. For the sensor component, an electronic sensor is used, not a traditional mechanical sensor, which can more easily produce false alerts. The electronic deceleration sensor is small, simple and accurate. It only reflects speed change, and is not interfered with by environment factors.

Briefly, one preferred embodiment of the present invention is an emergency stop signaling device for vehicles, including a deceleration sensor which produces deceleration values, an Integrated Circuit control circuit which receives the deceleration values and produces LED activation control signals in response to input from the deceleration sensor or other inputs including the existing braking system or a manually activated button. An LED array lights in response to the LED activation control signals from the Integrated Circuit control circuit to produce various modes of LED activity, including exhibiting various levels of brightness. The deceleration sensor is preferably a digital deceleration sensor. The LED array may be a flexible LED array which may be a linear LED array, or it may be a portable LED array, which may be a linear LED array, or a circular LED. Preferably, the IC control circuit produces signals which activate the LED array to at least three levels of brightness or other variations in intensity, color or pattern, which including a tail light mode, a stop light mode, and a panic stop mode.

An advantage of the present invention is that this device is independent from the vehicle's existing electrical signal system and will not interfere with the vehicle's current signal system.

Another advantage of the present invention is that this device can be used individually and also can be integrated with the vehicle's signal system to flash normal braking signals and tail light.

And another advantage of the present invention is that the electronic sensor is very precise compared to mechanical sensor and will not be easily triggered by environment factors, such as vibration. It only reflects the speed change.

A further advantage of the present invention is that the digital circuit simplifies the control circuit. A programmed IC is used which is easily used to set the deceleration value. When the deceleration reaches its preset value, the signal device turns on. It is accurate and has very little delay.

A yet further advantage of the present invention is that by using an LED Array as the lighting and signal component, its flashing pattern is unique and easily distinguished from ordinary stop lights.

Another advantage of the present invention is that it is able to display at least three modes of activity, including a normal braking stop, a stationary emergency stop and a panic stop.

An additional advantage of the present invention is that it utilizes LEDs, which can last thousands of hours and don't burn out like incandescent bulbs, and thus should seldom need replacement.

A further advantage of the present invention is that the structure of the device is very simple. It is an independent unit, and suitable for all existing automobiles on the market.

A yet further advantage of the present invention is that it is also easy to integrate with vehicle's current signal system to make the signal system multi-functional. It is suitable for development with new automobiles.

Yet another advantage of the present invention is that installation is simple. The flexible emergency stop signal device can be attached to the inside of a rear window shield directly. It is suitable to any curved surface since it is thin and flexible. The portable emergency signal device can be installed to the rear end of a vehicle easily.

Accordingly, it is a general purpose of the present invention to provide a specific emergency stop signal device for motor vehicle to improve the drivers' judgment to minimize accidents, and to provide a device which is convenient to install, convenient in use and which requires less maintenance.

These and other advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 illustrates a block diagram of the major components of the emergency stop signal device of the present invention;

FIG. 2 illustrates a block diagram of the major components of the control circuit of the present invention;

FIG. 3 illustrates a circuit diagram of the control circuit of the present invention;

FIG. 4 shows a flowchart of the operation of the emergency stop signal device of the present invention;

FIG. 5 illustrates a front view of the linear LED array of the present invention;

FIG. 6 illustrates a front view of the circular LED array of the present invention;

FIG. 7 illustrates a partial cut-away view of the circular portable emergency stop signal device of the present invention;

FIG. 8 illustrates a front view of a linear portable emergency stop signal device of the present invention; and

FIG. 9 illustrates a view of a linear portable emergency stop signal device of the present invention installed in the rear window of a vehicle.

### BEST MODE FOR CARRYING OUT THE INVENTION

The present invention is an emergency stop signal device for vehicles, which uses an LED Array to display a series of flashing lights in patterns and colors. The present invention shall be indicated in the following discussion and figures by the designation emergency stop signal device 10. The emergency stop signal device 10 is easily distinguished from normal brake lights and is easily recognized by other drivers as signaling an emergency condition. The emergency stop signal device 10 preferably has multiple modes of activity and turns on brightly when a deceleration sensor has reached a preset value of deceleration. It only reflects the change in acceleration, and not the driver's actions or jolts caused by road conditions, as may prior devices. It warns the driver of following vehicles to keep a safe distance from the user's vehicle in order to avoid rear-end collisions.

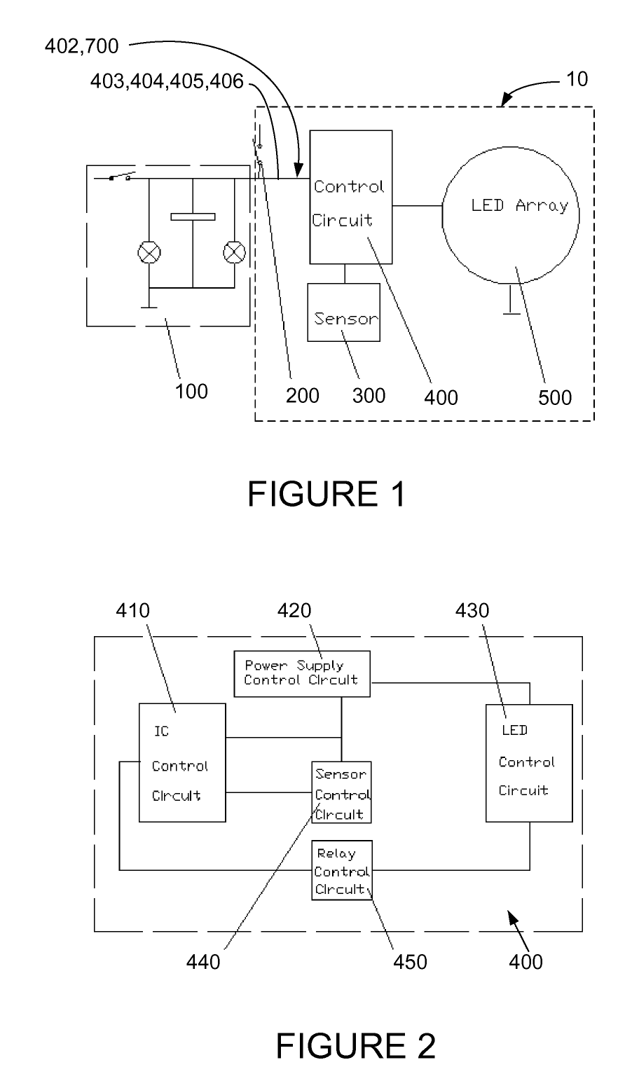

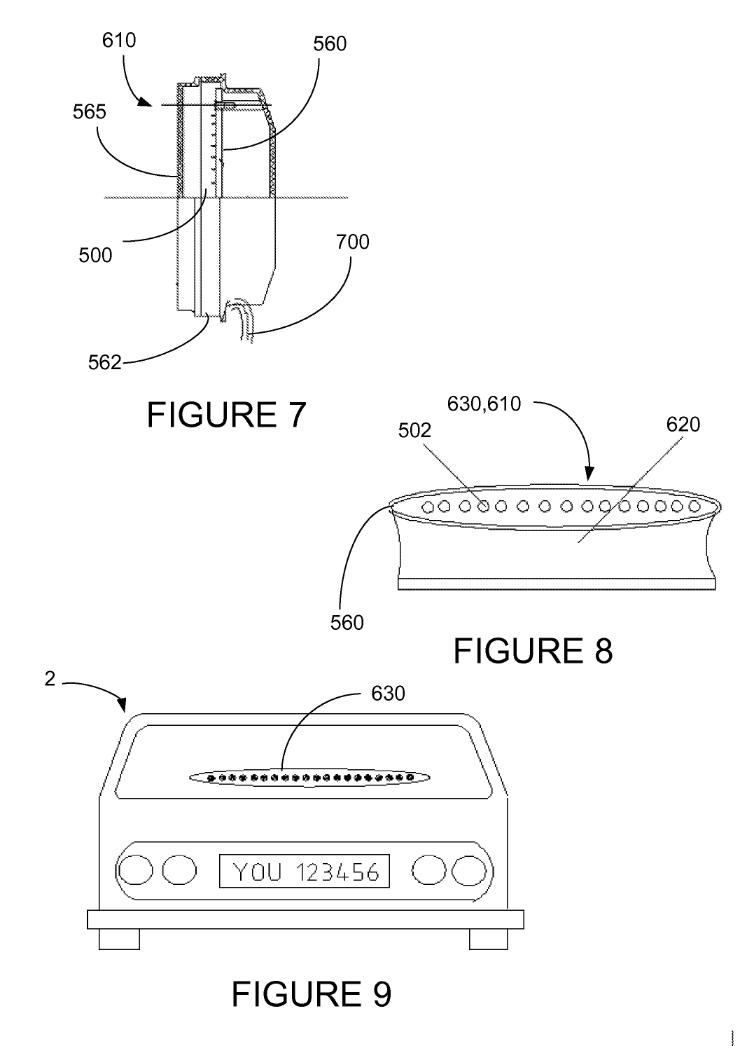

With reference to the drawings, FIG. 1 and FIG. 2, the emergency stop signal device 10 includes a deceleration sensor 300, an LED Array 500, and an integrated circuit (IC) control circuit 400. An input line 402 connects to an input of the emergency stop signal device 10 and accepts input from the existing braking signal system 100 and from the taillight system (not shown). This input line 402, which also corresponds to the power and data cord 700 seen below in FIG. 7, is also connected in parallel to a conventional emergency switch 200 to allow manual input from the emergency stop signal device 10. The input line 402 is preferably includes four wires, including a 12V power supply line 403, a ground wire 404, a wire which provides on/off state data from the existing taillight system, taillight status wire 405 and a fourth wire that provides on/off state data from the existing braking system, brake light status wire 406.

The deceleration sensor 300 detects changes in the speed of the vehicle, specifically drastic deceleration when a vehicle makes an emergency stop. When the deceleration amount reaches a predetermined value, the deceleration sensor 300 triggers the IC control circuit 410 to produce a special pulse signal and operate the LED array to begin flashing and moving in a specific direction and frequency, and optionally to also change colors.

The deceleration sensor 300 preferably is a completely digital electronic unit, and thus is not prone to false-activations caused by the driver's actions or jolts caused by road conditions, as may prior devices. One such type of digital deceleration sensor 300 is a surface micro-machined integrated-circuit accelerometer. The unit includes a surface micro-machined capacitive sensing cell and a COMOS signal conditioning ASIC contained in a single integrated circuit package. The capacitive sensing cell is a mechanical structure formed from semiconductor materials. It can be modeled as two stationary plates with a moveable plate in-between. The central plate can be deflected from its rest position by subjecting the system to a acceleration. When the center plate deflects, the distance from it to one fixed plate will increase by the same amount that the distance to the other plate decreases. The change in distance is a measure of acceleration. The capacitive sensing cell plates form two back-to-back capacitors. As the center plate moves with acceleration, the distance changes and each capacitors value will change. The CMOS ASIC uses switched capacitor techniques to measure the capacitors and extract the acceleration data from the difference between the two capacitors. The ASIC also signal conditions and filters the signal, providing a high level output voltage that is ratio-metric and proportional to acceleration.

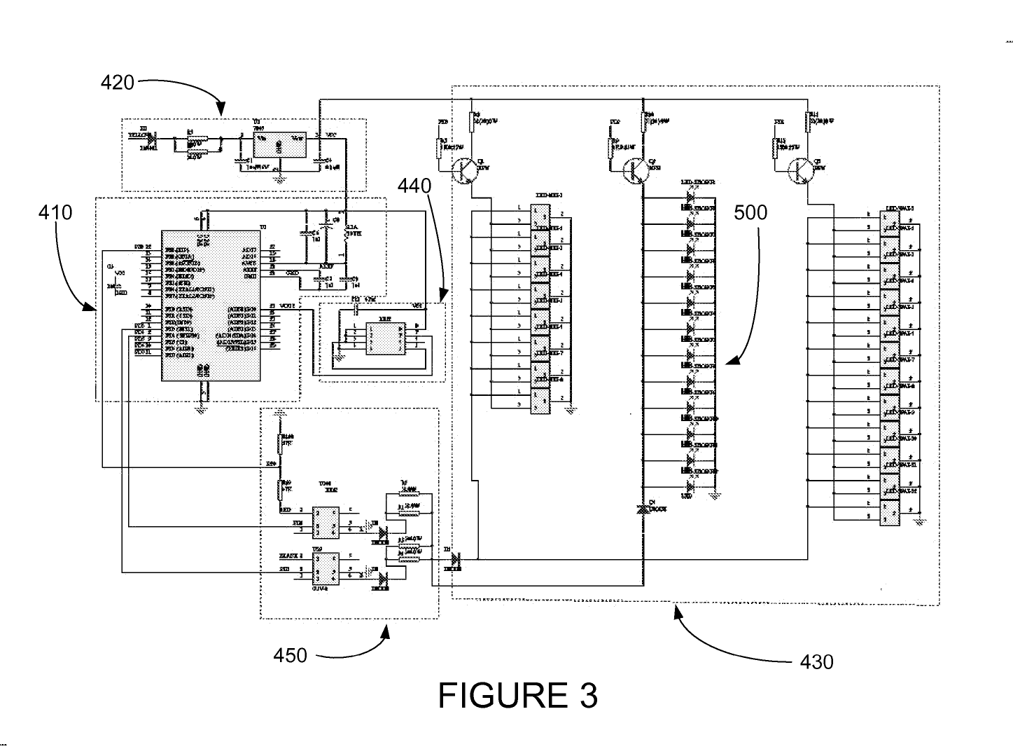

FIGS. 2 and 3 show the control circuit in more detail. The IC control 410 can be a micro-processor or other processing device and it receives input from the deceleration sensor 300 (see FIG. 1) and from the input line 402 which triggers it to send control signals to LED array 500 and thus activate various signal patterns and/or modes of illumination.

The power supply control circuit 420 converts the +12V inputs from the power input wire 403, taillight status line 405 and brake light status line 406 of the input line 402 to +5V to power the device, because the standard voltage of the LEDs and IC control chips is +5V. The deceleration sensor 300 senses the deceleration. The sensor control circuit 440 collects data from sensor 300. When the deceleration data from the sensor 300 reached its critical threshold value to indicate a panic stop, the sensor control circuit 440 triggers the IC control circuit 410 to turn on the device. The LED control circuit 430 controls the LED Array 500 and the relay control circuit 450 activates the sequencing of the LED activation, through the LED control circuit 430. The IC control circuit 410 also contains a counter which controls how long the LED pattern 500 will flash.

As noted above, an input line 402, includes power line 403, ground line 404, taillight status line 405 and brake light status line 406. The taillight status line 405 and brake light status line 406 attach indirectly to inputs of the IC control circuit 410. The existing braking system 100 provides on/off state data from the existing braking system through brake light status line 406, so the IC control circuit is activated to send control signals to the LED array 500. The taillight system (not shown) similarly provides on/off state data by the taillight status wire 405 so the IC control circuit is activated to send control signals to the LED array 500 for a different LED activation mode.

The manual switch 200 is connected to the power supply line 403, so the power to the entire device can be enabled or disabled.

Preferably, the LED array 500 can be controlled to exhibit at least three modes of activity or illumination, beside being turned off.

Firstly, if the tail lights of the existing system are turned on, the on/off state data provided by the taillight status line 405 indicates an “on” condition and the IC control circuit 410 sends signals which activate all the LEDs 500 are on in weak light mode, to be called “tail light” mode.

Secondly, if the driver steps on the brake peddle, but in a non-panic mode, the on/off state data provided by the brake pedal status line 406 indicates an “on” condition and the IC control circuit 410 sends signals which activate all the LEDs 500 are turned on more brightly, to be called “stop light” mode. Thirdly, if the stop is made so suddenly that the deceleration sensor value exceeds the critical threshold value, the LEDs 500 turn on very brightly, in a distinctive pattern, which indicates a “panic stop” mode. Its brightness is designed to conform to U.S. FMVSS 108 Safety Standard.

It should be understood that the modes of activity discussed here are not to be construed as limited to the three modes discussed above. There may be fewer modes or more than three, and the modes may include variations other than changes in brightness. These other variations may include changes in color, or exhibition of various patterns which correspond to the various modes.

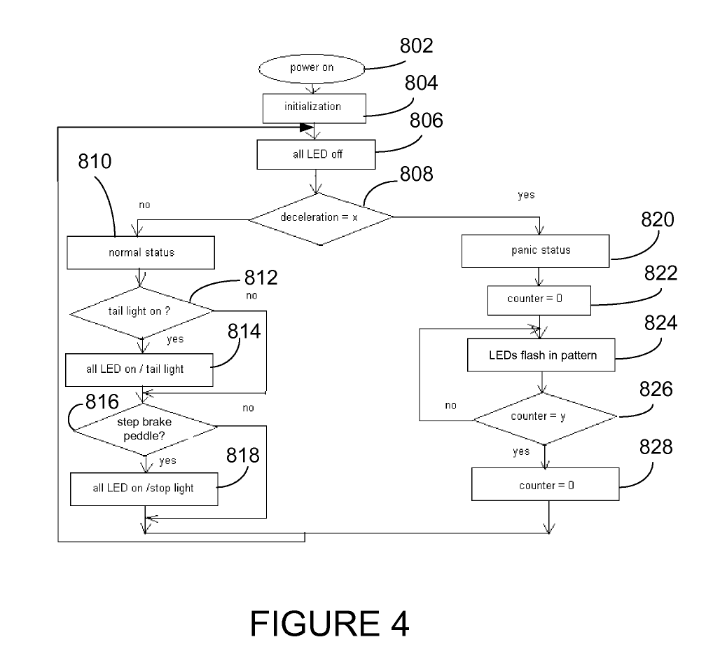

FIG. 4 shows a flowchart of the operation of the emergency stop signal device 10. The signal device connects to the power source, when the power is turned on 802. The system initializes 804, and the device sets all LED off 806. The predetermined deceleration value in order to trigger the IC control circuit shall be referred to as “X”. A decision 808 is made based on the output of the vehicle's deceleration sensor. When a vehicle's deceleration is less than the critical X value, the vehicle is in normal status 810 (deceleration=X is “No”).If the tail lights are turned on, all LEDs are on in weak light mode, (“tail light” mode 814). If the driver steps on the brake peddle 816, all the LEDs light more brightly (“stop light” mode 818). This is operation for a normal, non-panic stop.

When a vehicle's deceleration reaches its predetermined critical value X, it is in panic status 820 (see right boxes). The counter of the number of flashes in the IC control circuit 410 initializes as zero 822, and the signal device displays an emergency signal which flashes in a pattern 824, in a specific direction and may optionally change colors. When the number of flashes recorded by the counter reaches the counter preset value Y, (counter=y? 826), the counter will reset to zero again 828, and the emergency signal stops (all LED off 806).

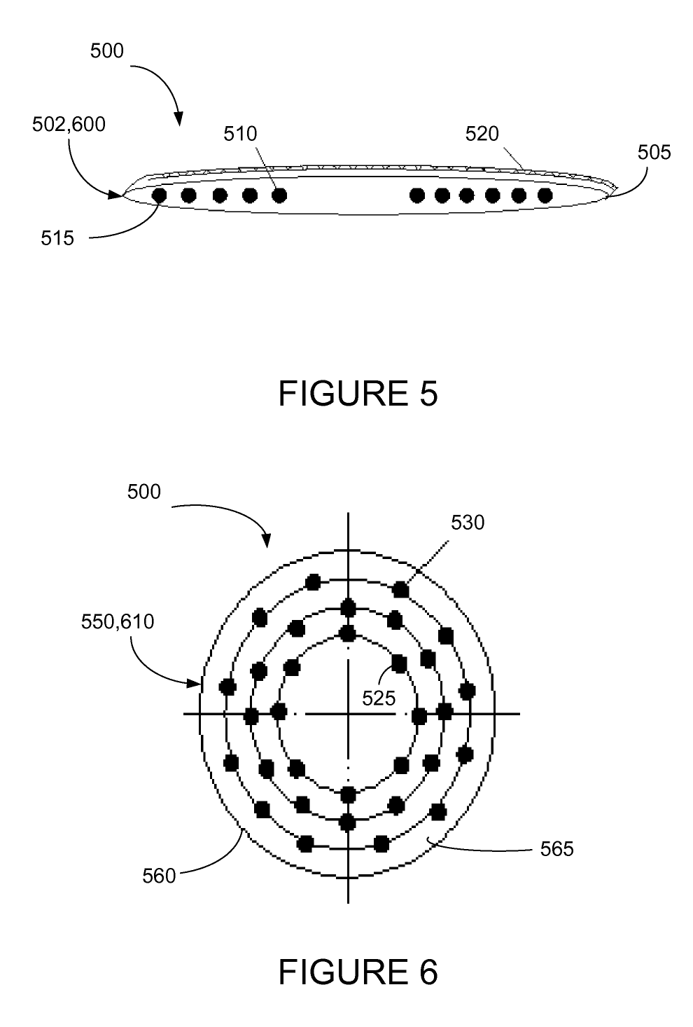

Two possible variations of the LED arrays 500 are shown in FIGS. 5 and 6. FIG. 5 shows a linear signal device 502, which can be used individually or as a substitute for the existing standard central brake light. The linear signal device 502 preferably flashes from the center-most LEDs 510 to the outer-most LEDs 515 in specific a frequency and with defined colors, such as single red, or single amber, red and amber, or red, amber and green.

FIG. 6 shows a circular LED array 550, which can also be used individually or integrated with the vehicle's current signal system to flash normal turning signals and tail lights. As emergency signal, it preferably flashes from the center-most LEDs 525 of the inner circle to the outer-most LEDs 530 from the outer circle in specific frequency and colors, again, such as single red, or single amber, red and amber; red, amber and green. Alternately, the lights of the circular LED array 550 may flashing in a swirl pattern, other some other configuration which will be a distinctive identifier of the panic stop.

The emergency stop signal device 10 also comes in at least two variations based on the physical type of LED array 500 which is used. The first variation is the flexible emergency stop signal device 600, which preferably includes a flexible printed integrated circuit 505 in the linear LED array 510 design which covered by a clear, elastic plastic material 520 (see FIG. 5). Therefore, the whole display device is flexible, and may be conformed to many surfaces, wrapped around corners, etc. It can be attached to the inside of a rear window shield directly (see FIG. 9).

The second type shall be termed the portable emergency stop signal 610, which includes a hard printed integrated circuit 560, preferably in the configuration of a circular LED array 550 (see FIG. 6) which is installed within a cover 565 or integrated with vehicle's current signal system. The term “portable” is used to indicate that the signal is easily locatable in various parts of the vehicle, such as the rear window with little reworking of the vehicle to fit the signal.

FIG. 7 shows a side partial cross-section view of a portable emergency signal 610. The portable emergency signal 610 includes a case 562, optional having a transparent cover 565, which encloses the LED array 500 and hard printed circuit 560. The power and signal cord 700 is included which connects to the LED array 500, and carries activation signals and supply power to activate the LED array 500. The cord 700 splits to two parts, one connects to the power source (not shown) to operate the portable signal device 610 and another connects to a standard connector (not shown) to operate normal signals, such as the stop and tail lights.

FIG. 8 shows another variation of the portable emergency signal 610. It includes a hard printed circuit 560 with linear LED Array 502 and oval Device Base 620, which will be referred to as a linear portable emergency signal 630. It can replace an existing central brake light, or be mounted elsewhere on the vehicle as described above. FIG. 9 shows such a linear portable emergency signal 630 in use in the rear window of a vehicle 2.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### INDUSTRIAL APPLICABILITY

The present emergency stop signal device 10 is well suited for application in as a warning device in vehicles. The emergency stop signal device 10 uses an LED Array to display a series of flashing lights in patterns and colors, which is different from normal brake lights and is easily distinguished by other drivers as signaling an emergency condition. The emergency stop signal device 10 turns on brightly when a deceleration sensor 300 has reached a preset value of deceleration, and only reflects the change in acceleration, and not the driver's actions or jolts caused by road conditions, as may prior devices. It warns the driver of following vehicles to keep a safe distance from the user's vehicle in order to avoid rear-end collisions.

An input line 402 includes power line 403, ground line 404, taillight status line 405 and brake light status line 406. The taillight status line 405 and brake light status line 406 attach indirectly to inputs of the IC control circuit 410. The power supply control circuit 420 converts the +12V inputs from the power input wire 403, taillight status line 405 and brake light status line 406 of the input line 402 to +5V to power the device, because the standard voltage of the LEDs and IC control chips is +5V. The deceleration sensor 300 senses the deceleration. The sensor control circuit 440 collects data from sensor 300. When the deceleration data from the sensor 300 reached its critical threshold value to indicate a panic stop, the sensor control circuit 440 triggers the IC control circuit 410 to turn on the device. The LED control circuit 430 controls the LED Array 500 and the relay control circuit 450 activates the sequencing of the LED activation, through the LED control circuit 430. The IC control circuit 410 also contains a counter which controls how long the LED pattern 500 will flash.

If the tail lights of the existing system are turned on, the on/off state data provided by the taillight status line 405 indicates an “on” condition and the IC control circuit 410 sends signals which activate all the LEDs 500 are on in weak light mode, to be called “tail light” mode.

If the driver steps on the brake peddle, but in a non-panic mode, the on/off state data provided by the brake pedal status line 406 indicates an “on” condition and the IC control circuit 410 sends signals which activate all the LEDs 500 are turned on more brightly, to be called “stop light” mode.

If the stop is made so suddenly that the deceleration sensor value exceeds the critical threshold value, the LEDs 500 turn on very brightly, in a distinctive pattern, which indicates a “panic stop” mode.

The emergency stop signal device 10 can be configured in any of a number of variations, including a linear signal device 502, or a circular LED array 550, which can be used individually or integrated with the vehicle's current signal system to flash normal turning signals and tail lights. The emergency stop signal device 10 also comes in at least two variations based on the physical type of LED array 500 which is used, namely a flexible emergency stop signal device 600, which preferably includes a flexible printed integrated circuit 505, and a portable emergency signal 610, which includes a hard printed integrated circuit 560, which can be in the configuration of a circular LED array 550 or as a linear portable emergency signal 630.

For the above, and other, reasons, it is expected that the emergency stop signal device 10 of the present invention will have widespread industrial applicability. Therefore, it is expected that the commercial utility of the present invention will be extensive and long lasting.

What is claimed is:

1. An emergency stop signaling device for vehicles, comprising:
a deceleration sensor which produces deceleration values;
an integrated circuit control circuit which receives said deceleration values from said deceleration sensor and which is configured to produce a plurality of LED activation control signals which activate said LED array to a plurality of modes of activity; and
an LED array which lights in response to said LED activation control signals from said integrated circuit control circuit.

2. The emergency stop signaling device of claim 1, wherein:
said deceleration sensor is a digital deceleration sensor.

3. The emergency stop signaling device of claim 1, wherein:
said LED array is a flexible LED array.

4. The emergency stop signaling device of claim 1, wherein:
said LED array is a portable LED array.

5. The emergency stop signaling device of claim 1, wherein:
said LED array is a linear LED array.

6. The emergency stop signaling device of claim 1, wherein:
said LED is a circular LED.

7. The emergency stop signaling device of claim 1, wherein:
said integrated circuit control circuit produces signals which activate said LED array to at least three modes of activity.

8. The emergency stop signaling device of claim 7, wherein:
said three modes of activity include a tail light mode, a stop light mode, and a panic stop mode.

9. The emergency stop signaling device of claim 8, further comprising:
an input data line connected from an input of said integrated circuit control circuit to the existing tail light system of the vehicle, said input data line accepting input which triggers said integrated circuit control circuit to produce activation control signals which activate said LED array to exhibit said tail light mode of activity.

10. The emergency stop signaling device of claim 8, further comprising:
an input data line connected from an input of said integrated circuit control circuit to the existing braking system of the vehicle, said input data line accepting input which triggers said IC control circuit to produce activation control signals which activate said LED array to exhibit said stop light mode of activity.

11. The emergency stop signaling device of claim 8, wherein:
a critical threshold value of deceleration provided by said deceleration sensor to said integrated circuit control circuit triggers said integrated circuit control circuit to produce activation control signals which activate said LED array to exhibit said panic stop mode of activity which is distinguishable from an ordinary stop signal.

12. An emergency stop signaling device for vehicles, comprising:
a digital deceleration sensor which produces deceleration values;
a control circuit which receives said deceleration values from said digital deceleration sensor and produces LED activation control signals; and
an LED array which lights in response to said LED activation control signals from said control circuit.

13. The emergency stop signaling device of claim 12, wherein:
said control circuit is an integrated circuit control circuit.

14. The emergency stop signaling device of claim 12, wherein:
said integrated circuit control circuit produces signals which activate said LED array to at least three modes of activity, which include a tail light mode, a stop light mode, and a panic stop mode.

15. The emergency stop signaling device of claim 12, wherein:
said LED is a flexible LED.

16. The emergency stop signaling device of claim 12, wherein:
said LED array is a portable LED array.

17. The emergency stop signaling device of claim 12, wherein:
said LED is a linear LED.

18. The emergency stop signaling device of claim 12, wherein:
said LED is a circular LED.

19. An emergency stop signaling device for vehicles, comprising:
a deceleration sensor which produces deceleration values in response to deceleration of a vehicle;
a control circuit which receives said deceleration values from said deceleration sensor and produces LED activation control signals; and
a flexible LED array which lights in response to said LED activation control signal from said control circuit, said flexible LED array producing a light pattern which is distinguishable from an ordinary stop signal.

20. The emergency stop signaling device of claim 19, wherein:
said LED is a linear LED.

21. The emergency stop signaling device of claim 19, wherein:
said deceleration sensor is a digital deceleration sensor.

22. The emergency stop signaling device of claim 19, wherein:
said control circuit is an integrated circuit control circuit.

23. The emergency stop signaling device of claim 22, wherein:
said integrated circuit control circuit produces signals which activate said LED array to at least three modes of activity, which include a tail light mode, a stop light mode, and a panic stop mode.
